(19) United States
(12) Patent Application Publication
(10) Pub. No.: US 2008/0274384 A1
(43) Pub. Date: Nov. 6, 2008

(54) SELF-REGULATING HYDROGEN GENERATOR FOR USE WITH A FUEL CELL

(75) Inventors: Gennadi FINKELSHTAIN, Shoham (IL); Yuri KATSMAN, Hadera (IL); Michael LERNER, Kiddush-Ha-Shem (IL)

Correspondence Address: GREENBLUM & BERNSTEIN, P.L.C., 1950 ROLAND CLARKE PLACE, RESTON, VA, 20191, US

(73) Assignee: MORE ENERGY LTD., Lod (IL)

(21) Appl. No.: 11/742,801

(22) Filed: May 1, 2007

(51) Int. Cl. H01M 8/22

(52) U.S. Cl. 429/19

(57) ABSTRACT

A hydrogen generation device includes a liquid fuel chamber, a catalytic hydrogen generation chamber, a hydrogen collection chamber and separation elements between these chambers. Once a certain hydrogen pressure in the device is reached liquid fuel is substantially prevented from being catalytically converted into hydrogen, whereby the production of hydrogen is stopped until hydrogen is allowed to exit the device to lower the pressure therein. This Abstract is not intended to define the invention disclosed in the specification, nor intended to limit the scope of the invention in any way.

### BACKGROUND OF THE INVENTION

1. Field of the Invention

The present invention relates to a self-regulating hydrogen generator which is based on the catalytic reaction of one or more substances which results in the formation of hydrogen gas. The hydrogen generator may be used, for example, as hydrogen providing device for a hydrogen-based fuel cell system. The invention is also directed to a method of producing hydrogen gas in a self-regulating manner.

2. Discussion of Background Information

There are several devices which use hydrogen in elemental form for generating electrical, mechanical or thermal energy such as, e.g., fuel cells, internal combustion engines and gas torches. Examples of disadvantages of hydrogen gas are that it is highly flammable and difficult and dangerous to handle. It is therefore desirable to have available a hydrogen gas providing system with which hydrogen gas can be produced while it is consumed, thereby avoiding the need for storing large quantities of hydrogen. Particularly when relatively small hydrogen consuming devices such as, e.g., fuel cells for generating electrical energy for appliances such as portable electronics and the like are used it is even more desirable to have available a hydrogen generation device which is capable of producing hydrogen gas in a self-regulating manner, i.e., a device which produces hydrogen while it is consumed by the hydrogen consuming device and automatically stops producing hydrogen when no hydrogen is consumed (for example, due to the hydrogen consuming device being in a non-operative or turned-off mode).

### SUMMARY OF THE INVENTION

The present invention provides a self-regulating hydrogen generation device or system which comprises at least three chambers and two separating elements between the chambers. The three chambers comprise:

(a) at least one first chamber (hereafter sometimes referred to as “liquid fuel chamber”) which is adapted for holding a liquid and at least one first substance which is a source of hydrogen and is at least partly soluble in the liquid;
(b) adjacent to the at least one first chamber, a second chamber (hereafter sometimes referred to as “hydrogen generation chamber”) which is adapted for holding at least one second substance which is capable of catalyzing a reaction which involves the at least one first substance and results in the formation of hydrogen gas;
(c) adjacent to the second chamber, a third chamber (hereafter sometimes referred to as “hydrogen collection chamber”) which is adapted for holding (hydrogen) gas and preferably comprises a valve system which can be activated to allow (hydrogen) gas to exit the third chamber.

Disposed between the first chamber and the second chamber is a first separation element which is liquid-permeable and capable of allowing liquid to pass from the first chamber into the second chamber.

Disposed between the second chamber and the third chamber is a second separation element which is substantially liquid-impervious and gas-pervious and thereby allows hydrogen gas that is present in the second chamber to pass into the third chamber but substantially prevents liquid that is present in the second chamber to pass into the third chamber.

In one aspect of the device, the liquid in the first chamber may comprise water. In another aspect, the at least one first substance may comprise a metal hydride compound and/or a borohydride compound such as, e.g., one or more of NaBH₄, KBH₄, LiBH₄, NH₄BH₄, Be(BH₄)₂, Ca(BH₄)₂, Mg(BH₄)₂, Zn(BH₄)₂, Al(BH₄)₃, polyborohydrides, (CH₃)₃NBH₃, and NaCNBH₃ and compounds of formulae MeH, MeAlH₄ and Me′H₂ wherein M=Li, Na and K and Me′=Be, Mg, Ca, Sr, Ba, Zn.

In another aspect of the device, the first chamber may be adapted for holding the at least one first substance in undiluted or concentrated form and, physically separated therefrom, a liquid dilutent for diluting the at least one first substance prior to using the device for the generation of hydrogen. For example, the first chamber may comprise at least two compartments, a first compartment for holding the at least one first substance in undiluted or concentrated form and a second compartment for holding the liquid dilutent for diluting the at least one first substance. Further, the first chamber may comprise, for example, at least two puncturable and/or breakable containers, at least one of them holding the at least one first substance in undiluted or concentrated form and at least one of them holding the liquid dilutent for diluting the at least one first substance.

In another aspect of the device of the present invention, the at least one second substance may comprise a transition metal in elemental form and/or in the form of a transition metal compound such as, e.g., a transition metal oxide. Non-limiting examples of suitable transition metals include Pt, Pd, Ru, Rh, Ir, Au, Co, Ni and Fe. In one aspect, the at least one second substance may be supported on a carrier. Non-limiting examples of suitable carrier materials are those with a high surface area and, in particular, carriers which comprise carbon and/or a ceramic material. Materials such as active carbon, zeolites, silica, alumina and combinations thereof may be mentioned as specific examples of suitable carrier materials. The carrier may be present in various forms including, but not limited to, sheets, plates, honeycomb structures, cylindrical structures, granules and any combinations of two or more thereof.

In yet another aspect of the device of the present invention, the first separation element may comprise a porous membrane, preferably a hydrophilic membrane. The hydrophilic membrane may comprise one or more materials which are hydrophilic per se and/or one or more hydrophobic materials which have been made hydrophilic by a hydrophilization (surface) treatment. Suitable as hydrophilic membrane materials are all materials which can withstand a chemical attack by the materials contained in the first and second chambers. Non-limiting examples of suitable materials for the hydrophilic membrane include polymeric materials such as, e.g., polysulfones, polyurethanes, modified (e.g., sulfonated) polyethylene and modified polypropylene; metallic materials (such as hydrophilic meshes made from stainless steel and the like); hydrophilic ceramic materials; and hydrophilic cloth materials.

In one aspect, the first separation element (e.g., the hydrophilic membrane) may have a thickness of at least about 20 μm, e.g., at least 50 μm and/or a thickness of not more than about 250 μm, e.g., not more than about 200 μm. In another aspect, the first separation element may have a pore size of at least about 10 μm, e.g., at least about 20 μm and/or a pore size of not larger than about 100 μm.

In a still further aspect of the device of the present invention, the second separation element may comprise a porous membrane, preferably a hydrophobic membrane. The hydrophobic membrane may comprise one or more materials which are hydrophobic per se and/or one or more hydrophilic materials which have been made hydrophobic by a hydrophobizing (surface) treatment. Suitable as hydrophobic membrane materials are all materials which can withstand a chemical attack by the materials contained in the second chamber. Non-limiting examples of suitable materials for the hydrophobic membrane include polymeric materials such as, e.g., polytetrafluoroethylene, polyethylenes, polypropylenes, polyamides (e.g., produced by Gore, Pall, General Electric, Millipore and other companies), and the like; hydrophobic ceramic materials; and hydrophobic cloth materials.

In one aspect, the second separation element (e.g., the hydrophobic membrane) may have a thickness of at least about 20 μm, e.g., at least about 50 μm and/or a thickness of not more than about 300 μm, e.g. not more than about 250 μm. In another aspect, the second separation element may have a pore size of at least about 0.5 μm and/or a pore size of not more than about 5 μm.

In another aspect of the device of the present invention, the second separation element may comprise a membrane which has a gas permeability pressure which is not higher than a gas permeability pressure of a membrane which is comprised in the first separation element. For example, the membrane of the second separation element has a gas permeability pressure of from about 20 mbar to about 100 mbar.

In yet another aspect, at least the first chamber of the device of the present invention may further comprise a pressure compensating system. By way of non-limiting example, the pressure compensating system may comprise a hydrophobic membrane. Suitable materials for the hydrophobic membrane include those which are mentioned above in connection with the hydrophobic membrane for the second separation element.

In a still further aspect of the device of the present invention, at least a part of the walls of the first chamber thereof may be flexible. In particular, the presence of a flexible part is preferred in cases where the first chamber is to comprise containers for holding the at least one first substance in undiluted or concentrated form and the liquid dilutent therefor, which containers (e.g., bags or bladders made from plastic material) can be broken by application of pressure (i.e., compression) to release the contents thereof into the first chamber.

In yet another aspect, the device may further comprise a water absorption element. The water absorption element may, for example, comprise a porous hydrophilic matrix/support (for example, polyurethane and/or a hydrophilic foam, cloth and/or paper) and one or more water-absorbing components (comprising, e.g., (meth)acrylic acid and/or (meth)acrylate containing polymers such as Carbopols and polyacrylic acid, paper Quick-Solid, to name but a few). In a preferred embodiment, the water-absorption element has a toroidal shape. Typical (preferred) dimensions thereof include an internal dimension of from up to about 20 cm (about 3 cm to about 10 cm), an external dimension of from about 1 cm to about 30 cm (about 4 cm to about 15 cm), and a tore thickness of from about 0.1 mm to about 30 mm (about 0.5 mm to about 10 mm).

In another aspect, the device of the present invention may be portable. Portability is particularly preferred if the device is to be used in conjunction with a (portable) fuel cell or other hydrogen consuming device which is intended to provide electrical power for microelectronics, sensors and portable electronics (cell phones, laptops, PDAs, etc.).

In yet another aspect, the three chambers of the hydrogen generation device may have internal volumes of at least about 5 cm³, e.g., at least about 10 cm³, or at least about 20 cm³ and/or not more than about 2,000 cm³, e.g., not more than about 1,000 cm³, or not more than about 100 cm³ for the first chamber; and/or of at least about 0.1 cm³, e.g., at least about 0.5 cm³, or at least about 1 cm³ and/or not more than about 50 cm³, e.g., not more than about 10 cm³, or not more than about 5 cm³ for the second chamber; and/or of at least about 0.2 cm³, e.g., at least about 0.5 cm³, or at least about 1 cm³ and/or not more than about 100 cm³, e.g., not more than about 50 cm³, or not more than about 10 cm³ for the third chamber.

In a still further aspect, the device (and in particular the first chamber) may comprise one or more sealable ports for replacing exhausted components of the hydrogen generating system by fresh components.

The present invention also provides a self-regulating hydrogen generation device which comprises

(a) at least one first chamber which holds (i) a liquid which comprises water and (ii) at least one borohydride compound;
(b) adjacent to the at least one first chamber, a second chamber which holds at least one catalytically active substance which is capable of catalyzing the reaction of water and the at least one borohydride compound with the formation of hydrogen gas;
(c) adjacent to the second chamber, a third chamber which is capable of holding gas and preferably comprises a valve system which can be activated to allow hydrogen gas to exit the third chamber;
(d) disposed between the first chamber and the second chamber, a hydrophilic membrane which is liquid-permeable and capable of allowing liquid to pass from the first chamber into the second chamber; and
(e) disposed between the second chamber and the third chamber, a hydrophobic membrane which is substantially liquid-impervious and gas-pervious, thereby allowing hydrogen gas which is present in the second chamber to pass into the third chamber.

In one aspect of the device, the at least one borohydride compound may comprise one or more compounds selected from NaBH₄, KBH₄, LiBH₄, NH₄BH₄, Be(BH₄)₂, Ca(BH₄)₂, Mg(BH₄)₂, Zn(BH₄)₂, Al(BH₄)₃, polyborohydrides, (CH₃)₃NBH₃, and NaCNBH₃. Preferred compounds include NaBH₄, KBH₄, LiBH₄ and NH₄BH₄.

In another aspect, the first chamber may comprise the at least one borohydride compound in undiluted or concentrated form and, physically separated therefrom, a liquid dilutent for diluting the at least one borohydride compound prior to using the device for the generation of hydrogen.

In yet another aspect, the at least one catalytically active substance may comprise at least one of Pt, Pd, Ru, Rh, Ir, Au, Co, Ni and Fe in elemental form and/or as oxide. Further, the at least one catalytically active substance may be present on a carrier selected from carbon and ceramic materials. The carrier may, for example, be present as a sheet, a plate, a honeycomb structure, a cylindrical structure and/or in the form of granules.

In a still further aspect, the hydrophilic membrane may have a thickness of from about 20 μm to about 250 μm and a pore size of from about 10 μm to about 100 μm and/or the hydrophobic membrane may have a thickness of from about 20 μm to about 300 μm and a pore size of from about 0.5 μm to about 5 μm. Further, the hydrophobic membrane may have a gas permeability pressure of from about 20 mbar to about 100 mbar, this pressure being not higher than the gas permeability pressure of the hydrophilic membrane.

In another aspect of the device, the first chamber thereof may have an internal volume of from about 20 cm³ to about 100 cm³ and/or the second chamber thereof may have an internal volume of from about 0.1 cm³ to about 5 cm³ and or the third chamber thereof may have an internal volume of from about 0.2 cm³ to about 10 cm³.

The present invention also provides a combination or system which comprises the self-regulating hydrogen generation device as set forth above (including the various aspects thereof) and a hydrogen consuming device.

In one aspect, the hydrogen consuming device may comprise an element which is capable of activating a valve system which is comprised in the third chamber of the hydrogen generation device to allow hydrogen gas in the third chamber to pass into the hydrogen consuming device.

In another aspect of the system or combination, the hydrogen generation device may be capable of being sealingly connected to the hydrogen consuming device in a way such that hydrogen gas in the third chamber of the hydrogen generation device is able to pass into the hydrogen consuming device.

In yet another aspect of the system or combination, the hydrogen generation device and the hydrogen consuming device may be connected by a system which comprises a quick-butt joint.

In a still further aspect, the hydrogen consuming device may be an integral part of the hydrogen generation device. This represents an example of a case where it is possible to dispense with the valve system of the third chamber of the hydrogen generation device and the element of the hydrogen consuming device which is capable of activating the valve system to allow hydrogen gas to pass from the third chamber into the hydrogen consuming device. For example, the third chamber of the hydrogen generation device may at the same time form a part of the hydrogen consuming device. By way of non-limiting example, where the hydrogen consuming device comprises a fuel cell, the anode of the fuel cell may form a part of the walls of the third chamber of the hydrogen generation device.

In another aspect of the combination, the hydrogen consuming device may comprise a (hydrogen-based) fuel cell. Examples of suitable fuel cells for use in the combination include all fuel cells which use hydrogen as fuel. Typical fuel cells comprise an anode for the oxidation of hydrogen, a cathode for reducing a substance such as, e.g., oxygen and a chamber which comprises an electrolyte and is arranged between the cathode and the anode. The electrolyte may be in a solid, liquid, gel, matrix or any other suitable state. Examples of suitable catalytically active anode and cathode materials include those which are conventionally used in hydrogen-based fuel cells. For example, the fuel cell may be adapted for charging a portable electronic device and/or may be adapted to have an output of from about 1 wt to about 50 wt.

The present invention also provides a hydrogen-based fuel cell which is adapted for being sealingly connected to a device of the present invention as set forth above and for receiving hydrogen gas therefrom.

The present invention further provides a method of generating hydrogen gas in a self-regulating manner. The method comprises (preferably continuously) contacting a catalytic material with a liquid material which is capable of forming hydrogen gas when contacted with the catalytic material and using the hydrogen gas thus formed for substantially preventing fresh liquid material from contacting the catalytic material when a predetermined threshold gas pressure is reached.

In one aspect of the method, the method comprises using a self-regulating hydrogen generation device of the present invention as set forth above, including the various aspects thereof.

The present invention also provides a self-regulating hydrogen generation device wherein a catalytic material is contacted (preferably continuously) with a liquid material which is capable of forming hydrogen gas when contacted with the catalytic material and the hydrogen gas thus formed is used for substantially preventing fresh liquid material from contacting the catalytic material when a predetermined threshold gas pressure is reached. For example, in a three chamber self-regulating hydrogen generation device as set forth above the threshold gas pressure may be determined, inter alia, by the gas permeability pressures of the first and second separation elements.

The present invention also provides a combination or system which comprises the self-regulating hydrogen generation device and a hydrogen consuming device such as, e.g., a fuel cell.

The present invention also provides a method of generating hydrogen in a hydrogen generation device. The method comprises passing liquid fuel from a liquid fuel chamber (first chamber) of the device to an adjacent hydrogen generation chamber (second chamber), generating hydrogen gas in the hydrogen generation chamber and substantially preventing liquid fuel from passing from the hydrogen generation chamber to an adjacent hydrogen gas collection chamber (third chamber). The hydrogen gas from the hydrogen gas collection chamber may be transferred to a hydrogen consuming device such as, e.g., a fuel cell.

When the hydrogen generation device of the present invention is used in combination with a hydrogen consuming device such as, e.g., a fuel cell, hydrogen productivity/output can be provided by a self-regulating process and mainly depends on the hydrogen consumption by the fuel cell. This represents a significant improvement over existing hydrogen generator/fuel cell combinations. Hydrogen productivity of conventional hydrogen generation systems is typically provided by a special regulation device which provides water management. The present system, on the other hand, does not necessarily require any special device for water management.

Examples of advantages/benefits associated with the device of the present invention may include one or more of construction design simplicity, portability, durability, handling and safety of usage, and highly specific technical characteristics.

As mentioned above, the present hydrogen generation device can be used in combination with any hydrogen consuming device and is not limited to use in combination with fuel cells. Examples of other hydrogen consuming devices include (internal) hydrogen combustion engines and gas torches (e.g., for welding)

The hydrogen generation device of the present invention may be at least one of a stand-alone unit, a modular unit, and a portable unit. The first chamber may comprise a plurality of separate chambers or compartments. One of the separate chambers or compartments may comprise a (liquid) concentrate of the at least one first substance and another one of the separate chamber or compartments may comprise a dilutent for diluting the concentrate. The liquid used for concentrate and the liquid of the dilutent may be the same or different. Especially when the at least one first substance comprises a borohydride compound the liquid of the concentrate and the dilutent will preferably both comprise water. In this case, at least the concentrate will additionally comprise a substance which provides an alkaline environment such as, e.g., an alkali or alkaline earth metal hydroxide and/or ammonium hydroxide. Specific examples thereof include NaOH and KOH. For more detailed information on (borohydride-based) concentrates and corresponding dilutents reference is made to, e.g., co-pending U.S. patent application Ser. No. 11/475,063 filed Jun. 27, 2006 and entitled “Stationary Cartridge Based Fuel Cell System, Fuel Cell Power Supply System, and Method of Activating the Fuel Cell”, the entire disclosure whereof is expressly incorporated by reference herein.

It is to be appreciated that the at least one first substance may only partly be soluble in the liquid which is present in the first chamber, in which case the first chamber will comprise a dispersion (e.g., a suspension) instead of a solution.

It is also possible for the at least one first substance to be present in the first chamber in undiluted form (i.e., in solid, semi-solid or liquid form, depending on the type(s) of first substance(s) employed). In this case, the first chamber may contain a dilutent for the at least one first substance for forming a solution or a suspension of the at least one first substance. It is also possible for a part or all of the dilutent to be introduced into the first chamber only prior to using the device (e.g., for the first time), for example, through one or more sealable ports provided in one or more of the side walls of the first chamber. As set forth above, the dilutent and the undiluted or concentrated first substance may initially be present in the first chamber in physically separated form such as, e.g., in different compartments of the first chamber and/or in different containers (e.g., puncturable or breakable bags, bladders or boxes) contained in the first chamber. Further, the at least one first substance (undiluted or concentrated) may be present in the first chamber as such and the dilutent may be present in a container and vice versa (i.e., the at least one first substance may be present in a container and the dilutent may be present as such).

Both the hydrogen generation device and the hydrogen consuming device of the present invention may comprise a housing arrangement that is generally rectangular.

The combination or system of the present invention may further comprise a water absorption element and/or a sealing element which is adapted to provide sealing between the hydrogen generation device and the hydrogen consuming device when these devices are connected to each other.

Further, the first separation element of the hydrogen generation device of the present invention preferably comprises a hydrophilic membrane. The hydrophilic membrane may occupy all or only a part of the area of the first separation element, e.g. from about 20% to about 100% of the area of the first separation element. The same applies with respect to the second separating element and the hydrophobic membrane preferably comprised therein.

One non-limiting possible use for the device and combination of the present invention is the charging of portable devices like cell phones, laptops, PDAs etc. The hydrogen generation device of the present invention may also be used to provide hydrogen for, e.g., fuel cells and internal combustion engines in cars and/or for various industrial, residential, commercial and personal devices and uses. The combination of hydrogen generation device and fuel cell may, in particular, be used in or for different devices such as Microsystems—up to about 1 wt (for example, microelectronics, sensors, etc.). This combination may also be used in or for portable electronics requiring power from about 1 to about 50 wt (e.g., cell phones, laptops and other such devices). The combination may further be used by various power consuming devices which have power requirements from between about 50 wt to about 100 kW.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a side cross-section view of a first embodiment of a combination of a hydrogen generation device of the present invention (hereafter sometimes referred to as “hydrogen generator module”) and a fuel cell (hereafter sometimes referred to as “electrodes module”). The combination is shown in a state in which the hydrogen generator module and the electrodes module have been fully connected together;

FIG. 2 shows a side cross-section view of the hydrogen generator module used in the embodiment shown in FIG. 1. The hydrogen generator module is shown in a state before the hydrogen generator module is connected to the electrodes module;

FIG. 3 shows a front view of the hydrogen generator module shown in FIG. 2;

FIG. 4 shows a side cross-section view of the electrodes module used in the embodiment shown in FIG. 1. The electrodes module is shown in a state before the hydrogen generator module is connected to the electrodes module;

FIG. 5 shows a front view of the electrodes module shown in FIG. 4;

FIG. 6 shows an enlarged side cross-section view of a portion of the electrodes module and the hydrogen generator module in a state prior to the hydrogen generator module being fully connected to the electrodes module. The arrow indicates movement of the electrodes module towards the hydrogen generator module and deflection of the locking members which will cause a locking together of the electrodes module and the hydrogen generator module;

FIG. 7 shows an enlarged side cross-section view of a portion of the electrodes module and the hydrogen generator module in a state of hydrogen generation and transfer of the hydrogen from the hydrogen generator module to the electrodes module. The arrows indicate hydrogen gas flows and liquid fuel flows;

FIG. 8 shows an enlarged side cross-section view of a portion of the electrodes module and an electrical load connected thereto;

FIG. 9 shows an enlarged side cross-section view of a portion of the electrodes module and the hydrogen generator module in a connected state according to another embodiment of the invention. This embodiment is similar to that of FIG. 1 and also includes a secondary sealing system utilizing two O-rings;

FIG. 10 shows an enlarged side cross-section view of a portion of the electrodes module and the hydrogen generator module in a connected state according to another embodiment of the invention. This embodiment is similar to that of FIG. 1 and also includes a secondary sealing system utilizing an annular sealing member;

FIG. 11 shows a side cross-section view of a second embodiment of a hydrogen generator module in a state where the module is fully connected to an electrodes module. This embodiment is similar to that of FIG. 1 and also includes two separate breakable containers for the liquid fuel constituents and a perforated support member; and

FIG. 12 shows a side cross-section view of a third embodiment of a hydrogen generator module in a state where the module is fully connected to an electrodes module. This embodiment is similar to that of FIG. 1 and also includes a single breakable container for the fuel constituents and a perforated support member.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice. In the following the materials contained in the first (liquid fuel) chamber of the hydrogen generator module (e.g., at least one first substance and a liquid) will collectively be referred to as “liquid fuel”.

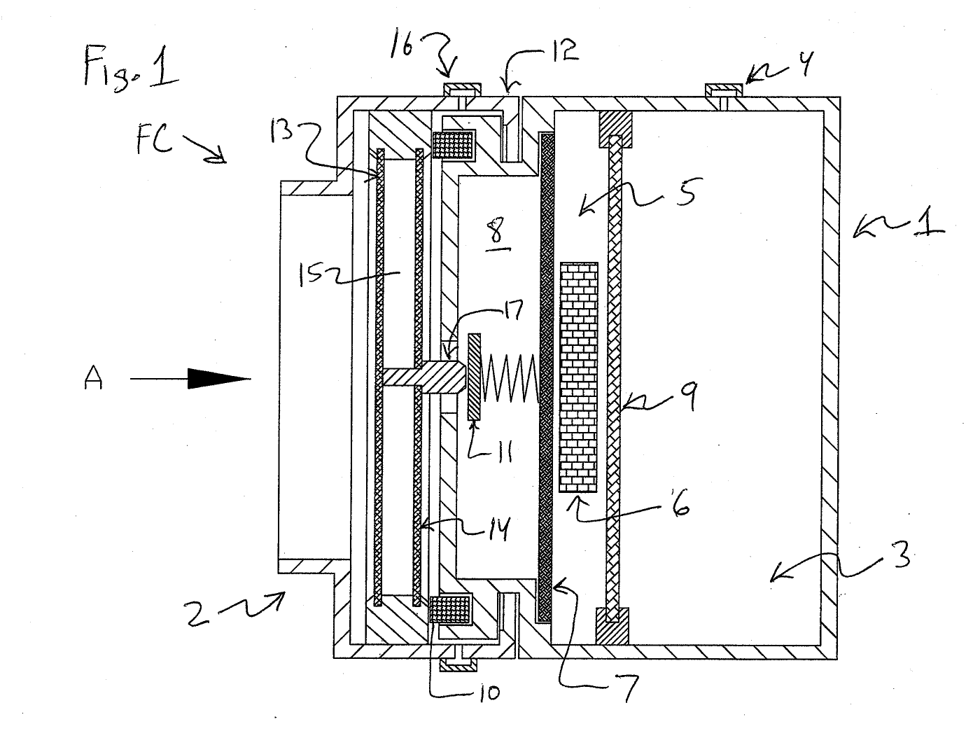

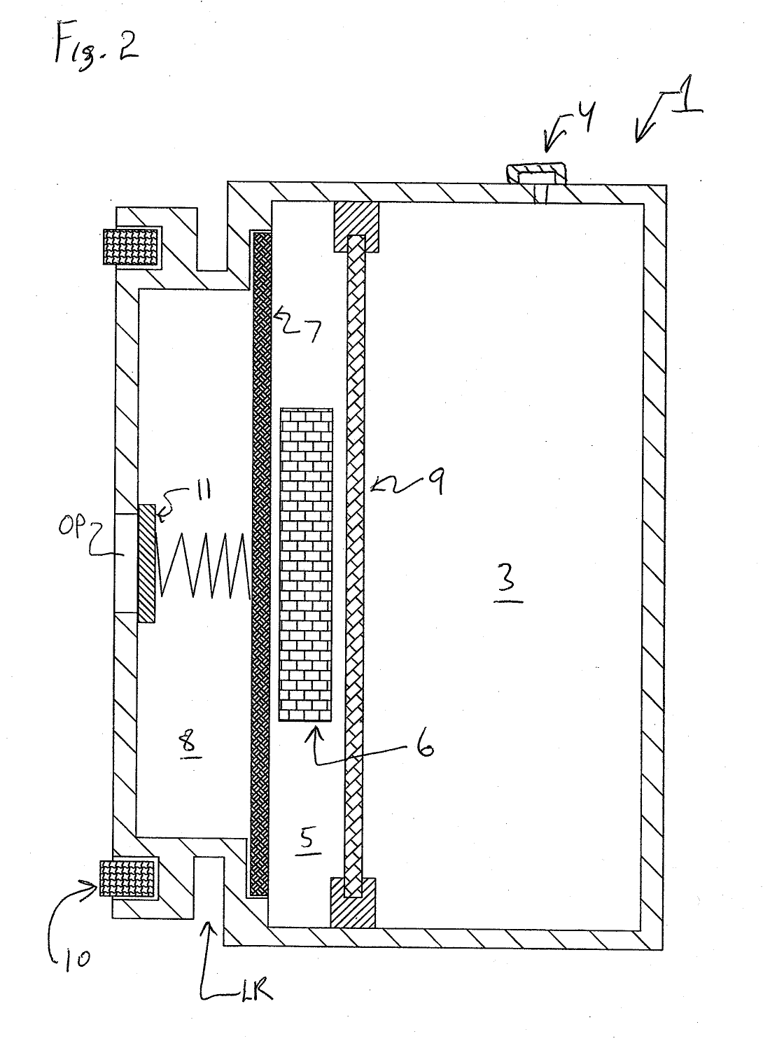

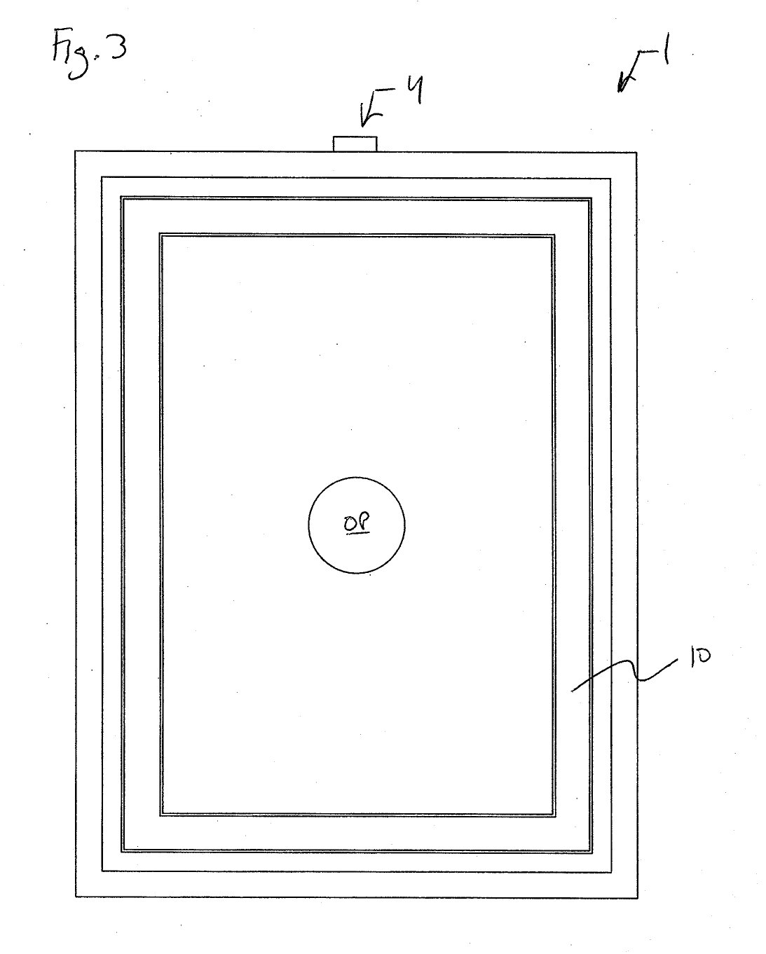

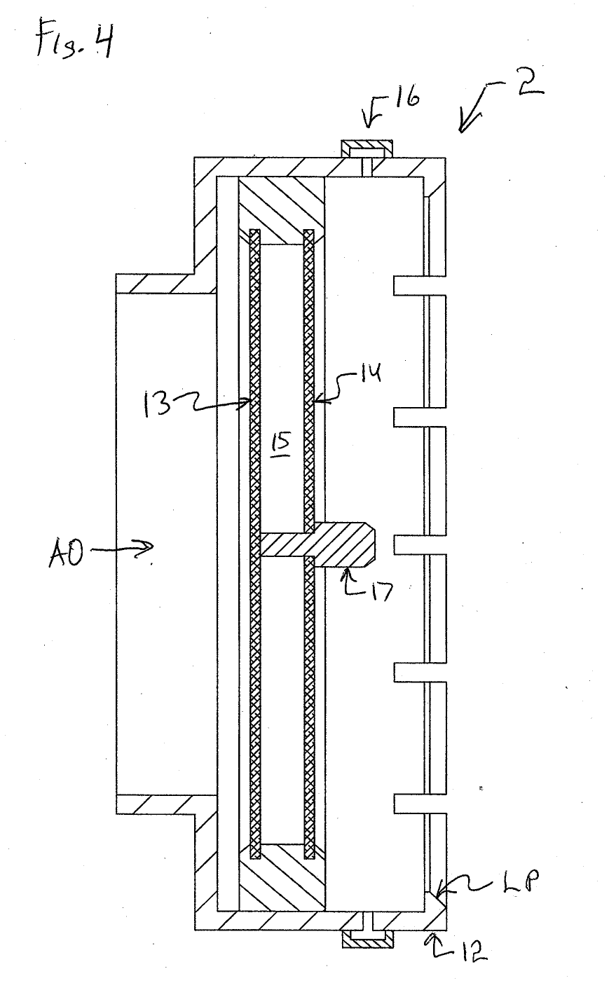

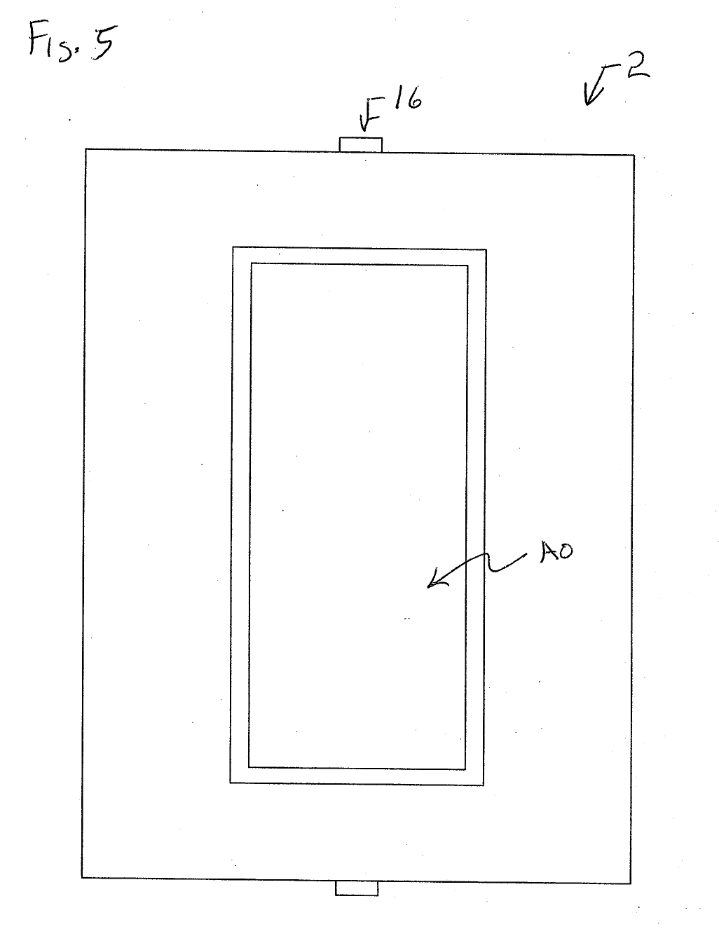

As is shown in FIGS. 1-5, the combination FC includes a hydrogen generator module or cartridge 1 and an electrodes module 2. The cartridge 1 includes a liquid fuel chamber 3 for storing a specified amount of liquid fuel, one or more, valves/vents 4, a hydrogen generation chamber 5, a catalytic element 6 arranged in the hydrogen generation chamber 5, a gas blocking element 9 as first separator element, a hydrogen collector chamber 8, a liquid fuel blocking element 7 as second separator element, an (annular) water absorption element 10, and a valve 11 for allowing hydrogen to pass into the electrodes module 2.

By way of non-limiting example, the liquid fuel chamber 3 may have a volume of from about 5 cm³ to about 2000 cm³, e.g., from about 20 cm³ to about 100 cm³. The hydrogen generation chamber 5 may have a volume of from about 0.1 cm³ to about 50 cm³, e.g., from about 0.5 cm³ to about 5 cm³. The hydrogen collector chamber 8 may have a volume of from about 0.2 cm³ to about 100 cm³, e.g., from about 1 cm³ to about 10 cm³.

The gas blocking element 9 separates the liquid fuel chamber 3 and the hydrogen generation chamber 8. The operating portion of the gas blocking element 9 is a membrane. This membrane is preferably a hydrophilic membrane. By way of non-limiting example, the membrane may occupy just a portion of the gas blocking element 9, e.g., from about 20% to 100% of the gas blocking element 9. The gas blocking element 9 functions by taking advantage of a capillary effect of the porous hydrophilic membrane. Liquid fuel in the porous membrane substantially prevents hydrogen crossover from the hydrogen generator chamber 5 to the liquid fuel chamber 3. At the same time, gas pressure substantially prevents liquid fuel penetration from the liquid fuel chamber 3 into the hydrogen generation chamber 5 in a non-operating condition of the electrodes module 2. A metal or non-metal hydrophilic mesh also may be used as the gas blocking membrane portion of element 9. By way of non-limiting example, the gas blocking membrane of element 9 can have a thickness of from about 20 μm to about 250 μm and a pore size of from about 10 μm to about 100 μm.

The hydrophilic porous membrane of the gas blocking element 9 can be made of any material that is stable in the liquid fuel medium. Non-limiting suitable examples of such a material include hydrophilic polymers such polysulfones, polyurethanes, modified PE, modified PP and others. The hydrophilic porous membrane can also have the form of a metallic hydrophilic mesh, e.g., made of stainless steel, and can also be made from hydrophilic ceramic materials and/or hydrophilic cloth materials.

The one or more valves/vents 4 can include or have the form of a pressure compensating membrane for the prevention of pressure pulsation which occurs during hydrogen generation. This membrane can be incorporated within the liquid fuel chamber 3. This membrane can be a hydrophobic membrane. Any hydrophobic porous material which is stable in the liquid fuel medium can be used as the membrane material, however, including one or more hydrophobic polymers such as, e.g., PTFE, PP, PE, polyamides (nylons) and others produced by Gore, Pall, General Electric, Millipore and other companies. The material can also comprise one or more hydrophobic ceramic materials and/or hydrophobic cloth materials.

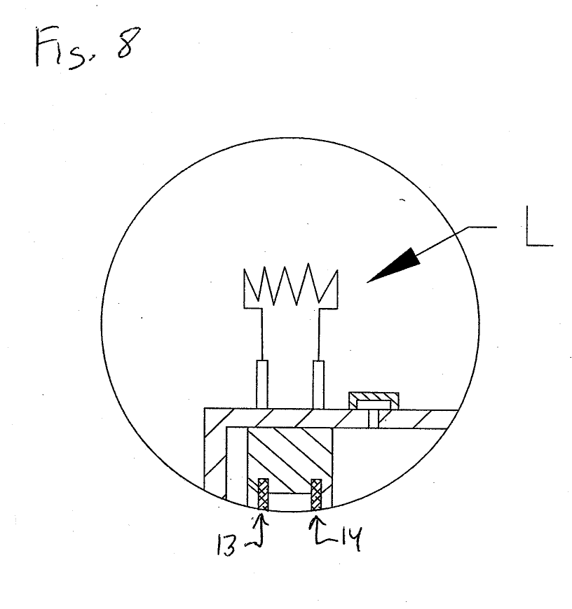

When the liquid fuel comprises a borohydride compound and water, the hydrogen generation chamber 5 functions as follows: hydrogen is produced by the following reaction: BH⁻₄+2H₂O=BO⁻₂+4H₂. The generated hydrogen is ultimately used to operate the electrodes module through the oxidation (consumption) of the hydrogen at the anode with concurrent production of electrical energy usable by a load L (see FIG. 8). Hydrogen is supplied to the electrodes module 2 according to the consumption thereof. In other words, when there is no consumption of hydrogen in the electrodes module 2 the pressure generated by the already produced hydrogen gas will prevent fresh liquid fuel from the liquid fuel chamber 3 to enter the hydrogen generation chamber 5, thereby stopping the production of hydrogen. Once the electrodes module operates again and consumes hydrogen, the hydrogen pressure will be reduced until fresh liquid fuel can enter the hydrogen generation chamber 3 again, resulting in the generation of further hydrogen which will be consumed by module 2, etc.

Of course, the present invention is not limited to the use of borohydride compounds as the source of hydrogen gas for the self-regulating hydrogen generation device of the present invention. Non-limiting examples of substances which may be used instead of or in combination with one or more borohydride compounds include metal hydrides and alumohydrides such as, e.g., compounds of formulae MeH (Me=alkali metal, in particular Li, Na and K), Me′H₂ (Me′=Zn or an alkaline earth metal such as, e.g., Be, Mg, Ca, Sr and Ba) and MeAlH₄ (Me=alkali metal, in particular Li, Na and K). Generally speaking, any substance or compound which is at least somewhat soluble in the liquid which is present in the at least first chamber, is stable per se under ambient (and, if needed, substantially moisture-free) conditions and can be decomposed (e.g., catalytically and/or thermally) to form hydrogen gas is suitable as a hydrogen source for use in the present invention.

The catalytic element 6 arranged within the chamber 5 may, for example, comprise one or more of the following as the catalytically active material: Pt, Pd, Ru, Rh, Ir, Au, Co, Fe, Ni (preferably as zero valency metals and/or oxides). The catalytically active material is preferably carried by a high surface area support, thereby forming the element 6. The catalytic element 6 may occupy only a portion of the hydrogen generation chamber 5. By way of non-limiting example, the catalytic element 6 may occupy from about 10% to about 90% of the volume of the chamber 5. The element 6 is preferably positioned in a central area of the chamber 5. By way of non-limiting example, with the exemplary dimensions of the chambers of the hydrogen generator module 1 set forth above, the distance between the catalytic element 6 and the gas blocking element 7 may be from about 0.1 mm to about 5 mm.

Examples of suitable materials for supporting the catalytically active material of the element 6 include different types of ceramic and carbon materials with a high surface area. The catalytic element 6 may be present in various forms and shapes including, e.g., a sheet, a plate, a cylindrical structure, a honeycomb structure, granules, etc.

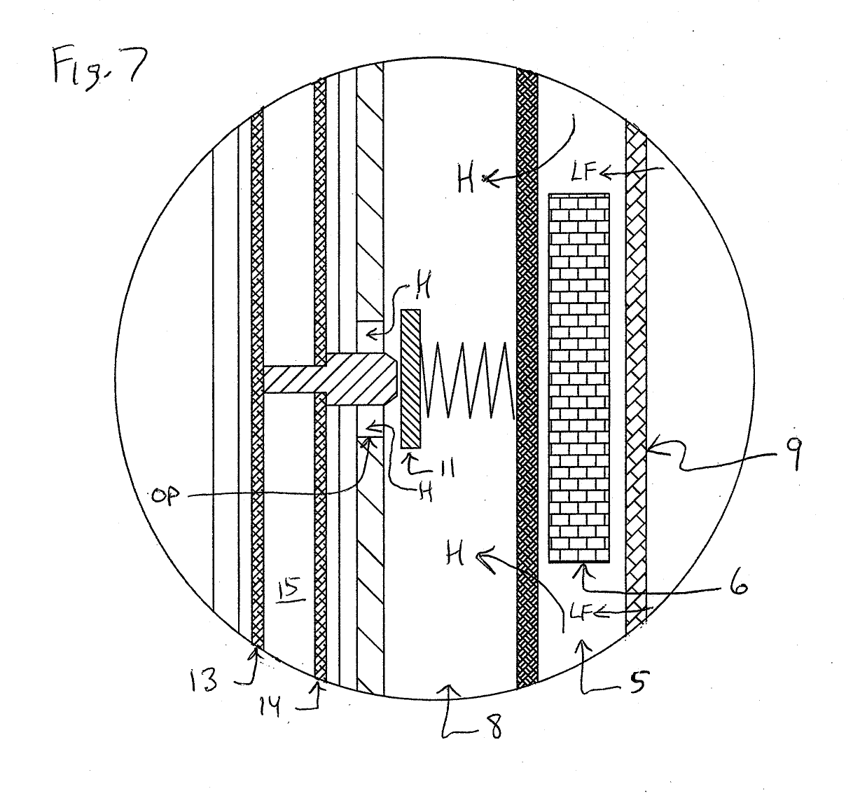

The liquid fuel blocking element 7 will usually be arranged on a side of the chamber 5 which is opposite the gas blocking element 9. Element 7 will usually comprise a porous membrane, preferably a hydrophobic membrane. The liquid fuel blocking membrane 7 will usually perform hydrogen and fuel separation in the hydrogen generator module 1; prevent leakage of liquid fuel out of the hydrogen generator chamber 5; act to clean and dry the gas passing through element 7; and allow hydrogen H pass into the gas collector chamber 8 (see FIG. 7). By way of non-limiting example, the liquid fuel blocking membrane of element 7 may have a thickness of from about 20 μm and about 300 μm, a pore size from about 0.5 μm to about 5 μm, and a gas permeability pressure of not from about 20 mbar to about 100 mbar. Also, the gas permeability pressure of the membrane of element 7 should not be higher than the gas permeability pressure of the membrane of element 9. By way of non-limiting example, the distance between catalytic element 6 and the liquid fuel blocking element 7 may be from about 0.1 mm to about 5 mm (with the exemplary dimensions of the various chambers of the module 1 set forth above).

The membrane of the liquid fuel blocking element 7 can be made of any hydrophobic porous material which is stable in the medium present in chamber 5 and which can be used as a membrane material. For example, the membrane can be made of one or more hydrophobic polymers such as PTFE, PP, PE, polyamides (nylons) and other materials produced by Gore, Pall, General Electric, Millipore and other companies. It can also be made of one or more hydrophobic ceramic materials and/or hydrophobic cloth materials.

The water absorption element 10 can comprise any porous hydrophilic matrix/support material such as, e.g., a polyurethane. It can also comprise a hydrophilic foam, cloth, and/or paper material. The matrix/support material may incorporate absorption components such as, e.g., Carbopols, polyacrylic acid, Quick-Solid paper and other materials. The element 10 may, for example, have a toroidal configuration with the following exemplary and non-limiting dimensions: an internal peripheral length of up to about 20 cm, and preferably from about 3 to about 10 cm; an external peripheral length of from about 1 cm to about 30 cm, and preferably from about 4 cm to about 15 cm; a cross-sectional thickness (tore) of from about 0.1 mm to about 30 mm, preferably from about 0.5 mm to about 10 mm.

The valve 11 may be biased towards a closed position by, e.g., a spring, and is moved to the open position upon engagement with a pin 17 which is arranged within the electrodes module 2 when the hydrogen generator module 1 and the electrodes module 2 are connected together via locking members 12. As is shown in FIG. 7, once the valve 11 is open, the hydrogen gas H is allowed to flow out of the chamber 8 of the hydrogen generator module 1 and into the electrodes module 2 via the opening OP.

The electrodes module 2 includes an anode 14, a cathode 13, an electrolyte chamber 15, a pin 17 for opening the valve 11, a system of deflectable locking members 12, one or more safety valves 16, and an air opening AO which allows outside air to enter into the electrodes module 2 (thereby providing oxygen for reduction at the cathode 13).

The safety valve 16 can be configured to open at pressures of from about 1 bar to about 1000 bar, and preferably opens at pressures from about 10 bar to about 50 bar. The valve 16 can also be replaced with a membrane of the type used in element 4.

Any type of hydrogen fuel cells may be used in combination with the hydrogen generator system of the present invention. For example, alkaline, acidic or PEM electrolytes may be used in the electrodes module 2. The electrolyte used in chamber 15 may be in the liquid state as well as solid, gel or matrix states.

The liquid fuel for the hydrogen generator module 1 may, for example, comprise borohydride based alkaline solutions. Furthermore, suspensions may be used as the liquid fuel as well. In this regard, reference is made to, e.g., U.S. Pat. Nos. 6,554,877, 6,592,497, 6,758,871 and 6,773,470 as well as to U.S. Patent Application No. 2005/0155279 and U.S. patent application Ser. No. 11/384,364, the entire disclosures whereof are incorporated by reference herein. All of these documents describe borohydride-based liquid fuel systems for liquid fuel cells which can be used as liquid fuel for the hydrogen generation device of the present invention. Of course the liquid fuel for use in the present invention is not limited to borohydride based fuels. Rather, any substance which can be used in a catalytic reaction which results in the formation of gaseous hydrogen is suitable for the purposes of the present invention.

As stated above, the liquid fuel can be stored in the fuel chamber 3 as single-component (e.g., borohydride-based) solution or suspension or as binary product composed of a fuel concentrate and a dilutent. Binary fuel usage may provide higher fuel stability, making it possible to store the liquid fuel in the module 1 on a long term basis (before usage).

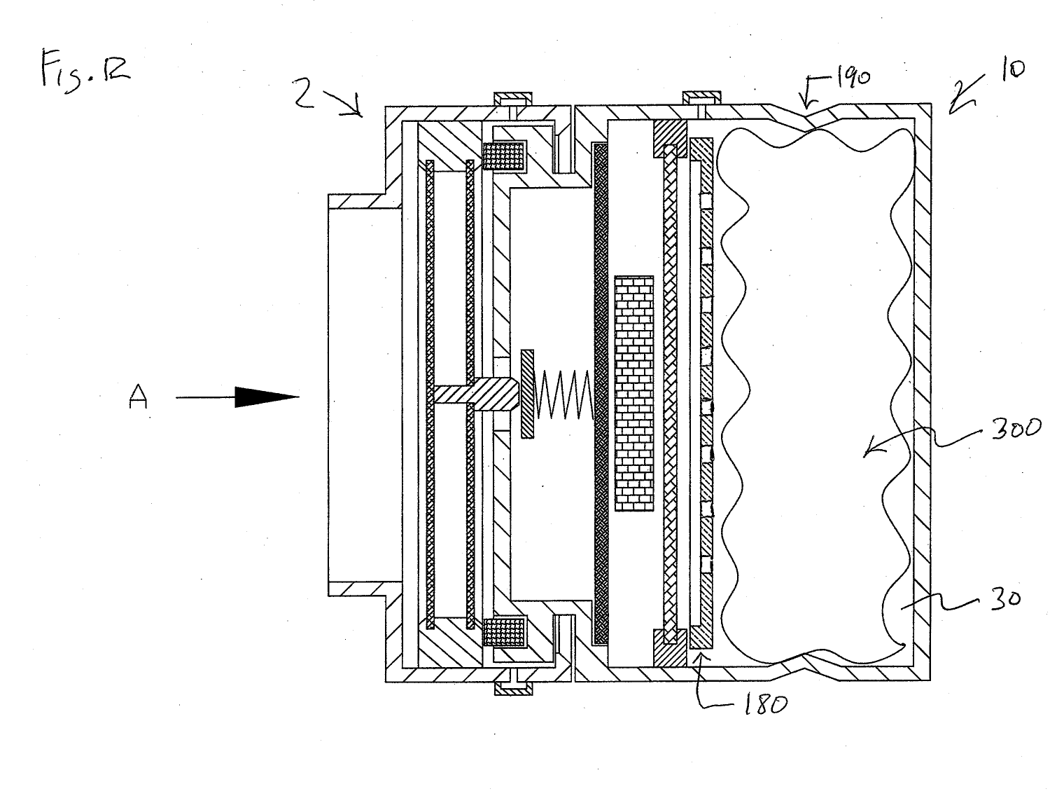

Solid borohydride based compositions (e.g., in the form of powders, granules, flakes or tablets) as well as liquid or semi-solid borohydride compositions (e.g., in the form of solutions, suspensions or pastes) represent non-limiting examples of materials which can be used as fuel concentrates. In this regard, the fuel concentrate and a dilutent can be placed in chamber 3 separately and/or in separate containers as is shown in the embodiment of FIG. 11. The concentrate and dilutent can be mixed just before the electrodes module 2 is to be utilized.

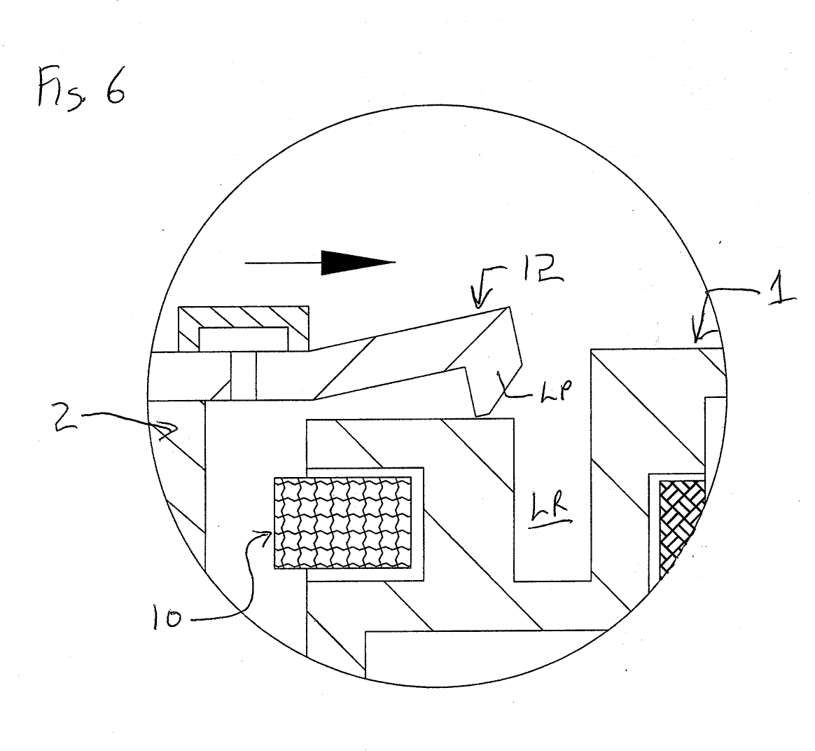

FIG. 6 illustrates how the locking members 12 deflect outwards as the modules 1 and 2 are moved into connection with each other. Once the modules 1 and 2 are fully connected, the projecting portions or locking projections LP of the members 12 snap into recesses LR formed in the module 1 (compare FIGS. 1 and 6).

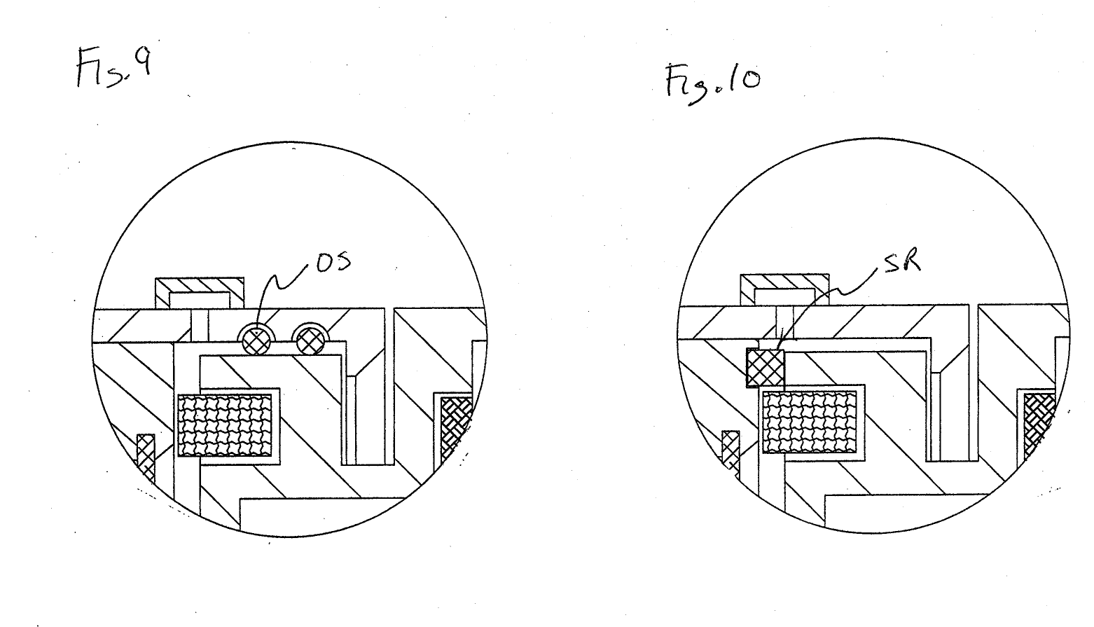

FIG. 9 shows one non-limiting way of providing additional sealing between the hydrogen generator module 1 and the electrodes module 2 when these modules are connected together. In this embodiment, two O-ring seals OS are used to provide sealing between these modules.

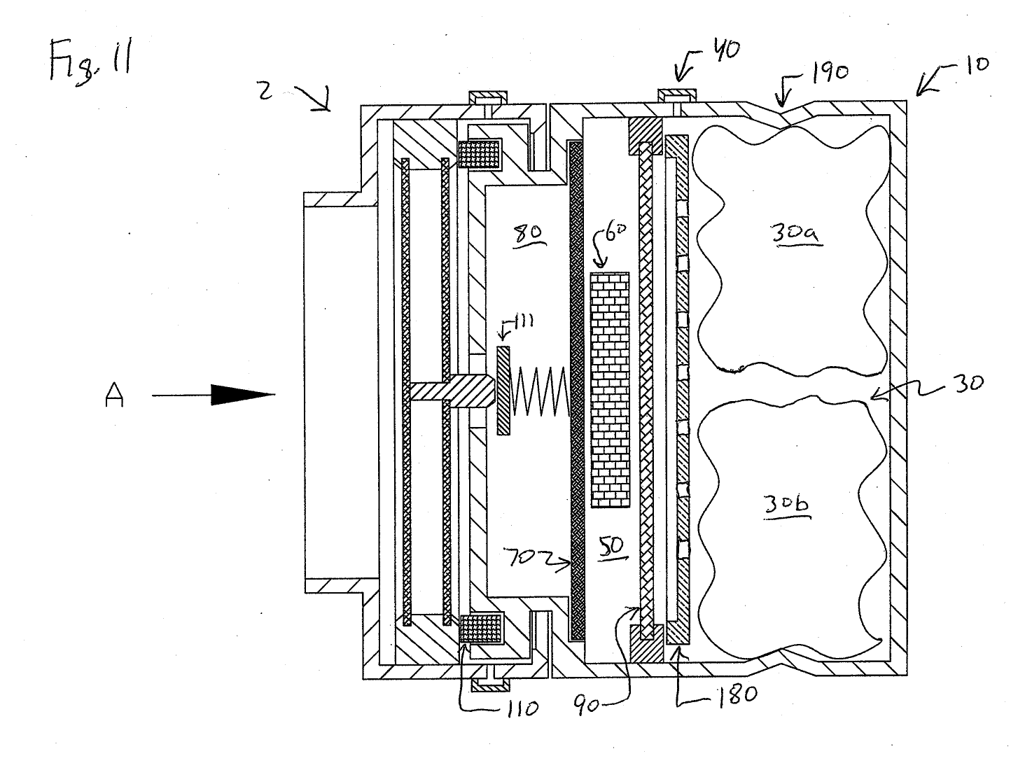

FIG. 10 shows another non-limiting way of providing additional sealing between the hydrogen generator module 1 and the electrodes module 2 when these modules are connected together. In this embodiment, a single sealing ring SR is used to provide sealing between these modules.

FIG. 11 shows another embodiment of a combination or system according to the present invention. This combination includes a hydrogen generator module or cartridge 10 and an electrodes module 2. The cartridge 10 is similar to that of FIG. 1 except that the liquid fuel chamber 30 for storing a liquid fuel houses two separate storage containers 30a and 30b. Each container 30a and 30b can have the form of a breakable flexible material bag which can be broken open when the user moves a rear wall of the module 10 towards the support 180. This movement is facilitated by one or more flexible sections or accordion folds 190 formed in the wall of the module 10. Thus, when a user moves the rear wall of module 10 towards the support 180, the bags 30a and 30b experience compression. When enough compressive pressure is applied to the bags 30a and 30b, they break open and spill their contents into the chamber 30. Furthermore, because the support 180 is perforated with openings, the fuel from the chamber 30 will be allowed to flow into the chamber 50 after passing through element 90. The combination will then function in the same way as the embodiment of FIG. 1. A fuel concentrate can be contained in container 30a and a dilutent can be placed in container 30b. The concentrate and dilutent can be mixed just before the electrodes module 2 is to be utilized. The hydrogen generator module 10 also includes one or more valves/vents 40, and a hydrogen generation chamber 50, a catalytic element 60 arranged in the hydrogen generation chamber 50, a liquid fuel blocking element 70, a hydrogen collecting chamber 80, a gas blocking element 90, an annular water absorption element 110, and a valve 111 for allowing hydrogen to pass into the electrodes module 2.

The bags 30a and 30b can be made of a puncturable and/or breakable material produced from typical contractual polymeric materials which are stable in the liquid fuel medium. These include, e.g., PP, PE, PVC and other materials.

The support element 180 can be made from any material which is stable in the liquid fuel medium. For example, it can be made of PE, PP, ABS, SS 316 and similar materials.

FIG. 12 shows another embodiment of the hydrogen generator/fuel cell combination or system of the present invention. This combination includes a hydrogen generator module or cartridge 10 and an electrodes module 2. The cartridge 10 is similar to that of FIG. 11 except that the liquid fuel chamber 30 houses a single large breakable container 300 which contains the liquid fuel. The container 300 can have the form of a breakable flexible material bag which can be broken open when the user moves a rear wall of the module 10 towards the support 180. This movement is facilitated by one or more flexible sections or accordion folds 190 formed in the wall of the module 10. Thus, when a user moves the rear wall of module 10 towards the support 180, the bag 300 experiences compression. When enough compressive pressure is applied to the bag 300, it breaks open and spills its contents into the chamber 30. Furthermore, because the support 180 is perforated with openings, the fuel from the chamber 30 will be allowed to flow into the chamber 50 after passing through element 90. The combination will then function is the same way as the embodiment of FIG. 1.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A self-regulating hydrogen generation device comprising:
(a) at least one first chamber for holding a liquid and at least one first substance which is a source of hydrogen and is at least partly soluble in the liquid;
(b) adjacent to the at least one first chamber, a second chamber for holding at least one second substance which is capable of catalyzing a reaction which involves the at least one first substance and results in the formation of hydrogen gas,
(c) adjacent to the second chamber, a third chamber which is capable of holding gas;
(d) arranged between the first chamber and the second chamber, a first separation element which is liquid-permeable and capable of allowing liquid to pass from the first chamber into the second chamber; and
(e) arranged between the second chamber and the third chamber, a second separation element which is substantially liquid-impervious and gas-pervious, thereby allowing hydrogen gas present in the second chamber to pass into the third chamber.

2. The device of claim 1, wherein the liquid comprises water.

3. The device of claim 1, wherein the at least one first substance comprises at least one of a borohydride compound and a metal hydride compound.

4. The device of claim 3, wherein the at least one first substance comprises at least one compound selected from NaBH₄, KBH₄, LiBH₄, NH₄BH₄, Be(BH₄)₂, Ca(BH₄)₂, Mg(BH₄)₂, Zn(BH₄)₂, Al(BH₄)₃, polyborohydrides, (CH₃)₃NBH₃, and NaCNBH₃.

5. The device of claim 3, wherein the at least one first substance comprises at least one compound selected from compounds of formulae MeH, MeAlH₄ and Me′H₂ wherein M=Li, Na, K and Me′=Be, Mg, Ca, Sr, Ba, Zn.

6. The device of claim 1, wherein the first chamber is adapted for holding the at least one first substance in undiluted or concentrated form and, physically separated therefrom, a liquid dilutent for diluting the at least one first substance prior to using the device for the generation of hydrogen.

7. The device of claim 6, wherein the first chamber comprises at least two compartments, a first compartment for holding the at least one first substance in undiluted or concentrated form and a second compartment for holding liquid dilutent for diluting the at least one first substance.

8. The device of claim 6, wherein the first chamber comprises at least two puncturable or breakable containers, at least one of them holding the at least one first substance in undiluted or concentrated form and at least one of them holding liquid dilutent for diluting the at least one first substance.

9. The device of claim 1, wherein the at least one second substance comprises at least one of a transition metal in elemental form and a transition metal oxide.

10. The device of claim 9, wherein the transition metal is selected from one or more of Pt, Pd, Ru, Rh, Ir, Au, Co, Ni and Fe.

11. The device of claim 1, wherein the at least one second substance is present on a carrier.

12. The device of claim 11, wherein the carrier comprises at least one of carbon and a ceramic material.

13. The device of claim 11, wherein the carrier is present as at least one of a sheet, a plate, a honeycomb structure, a cylindrical structure and granules.

14. The device of claim 1, wherein the first separation element comprises a hydrophilic membrane.

15. The device of claim 1, wherein the first separation element has at least one of a thickness of from about 20 μm to about 250 μm and a pore size of from about 10 μm to about 100 μm.

16. The device of claim 1, wherein the second separation element comprises a hydrophobic membrane.

17. The device of claim 1, wherein the second separation element has at least one of a thickness of from about 20 μm to about 300 μm and a pore size of from about 0.5 μm to about 5 μm.

18. The device of claim 1, wherein the second separation element comprises a membrane which has a gas permeability pressure which is not higher than a gas permeability pressure of a membrane which is comprised in the first separation element.

19. The device of claim 18, wherein the membrane of the second separation element has a gas permeability pressure of from about 20 mbar to about 100 mbar.

20. The device of claim 1, wherein at least the first chamber further comprises a pressure compensating system.

21. The device of claim 20, wherein the pressure compensating system comprises a hydrophobic membrane.

22. The device of claim 1, wherein the third chamber comprises a valve system which can be activated to allow gas to exit the third chamber.

23. The device of claim 1, wherein at least a part of walls of the first chamber is flexible.

24. The device of claim 1, wherein the device further comprises a water absorption element.

25. The device of claim 24, wherein the water absorption element has a toroidal shape.

26. The device of claim 1, which has at least one of an internal volume of the first chamber of from about 5 cm³ to about 2,000 cm³, an internal-volume of the second chamber of from about 0.1 cm³ to about 50 cm³, and an internal volume of the third chamber of from about 0.2 cm³ to about 100 cm³.

27. A self-regulating hydrogen generation device comprising
(a) at least one first chamber which holds (i) a liquid which comprises water and (ii) at least one borohydride compound;
(b) adjacent to the at least one first chamber, a second chamber which holds at least one catalytically active substance which is capable of catalyzing the reaction of water and the at least one borohydride compound with the formation of hydrogen gas;
(c) adjacent to the second chamber, a third chamber which is capable of holding gas; (d) arranged between the first chamber and the second chamber, a hydrophilic membrane which is liquid-permeable and capable of allowing liquid to pass from the first chamber into the second chamber; and
(e) arranged between the second chamber and the third chamber, a hydrophobic membrane which is substantially liquid-impervious and gas-pervious, thereby allowing hydrogen gas present in the second chamber to pass into the third chamber.

28. The device of claim 27, wherein the at least one borohydride compound comprises at least one compound selected from NaBH₄, KBH₄, LiBH₄, NH₄BH₄, Be(BH₄)₂, Ca(BH₄)₂, Mg(BH₄)₂, Zn(BH₄)₂, Al(BH₄)₃, polyborohydrides, (CH₃)₃NBH₃, and NaCNBH₃.

29. The device of claim 27, wherein the first chamber comprises the at least one borohydride compound in undiluted or concentrated form and, physically separated therefrom, a liquid dilutent for diluting the at least one borohydride compound prior to using the device for the generation of hydrogen.

30. The device of claim 27, wherein the at least one catalytically active substance comprises one or more of Pt, Pd, Ru, Rh, Ir, Au, Co, Ni and Fe in at least one of elemental and oxide form.

31. The device of claim 30, wherein the at least one catalytically active substance is present on a carrier selected from carbon and ceramic materials.

32. The device of claim 31, wherein the carrier is present as at least one of a sheet, a plate, a honeycomb structure, a cylindrical structure and granules.

33. The device of claim 27, wherein the hydrophilic membrane has a thickness of from about 20 μm to about 250 μm and a pore size of from about 10 μm to about 100 μm.

34. The device of claim 33, wherein the hydrophobic membrane has a thickness of from about 20 μm to about 300 μm and a pore size of from about 0.5 μm to about 5 μm.

35. The device of claim 34, wherein the hydrophobic membrane has a gas permeability pressure which is not higher than a gas permeability pressure of the hydrophilic membrane and is from about 20 mbar to about 100 mbar.

36. The device of claim 35, which has at least one of an internal volume of the first chamber of from about 20 cm³ to about 100 cm³, an internal volume of the second chamber of from about 0.1 cm³ to about 5 cm³, and an internal volume of the third chamber of from about 0.2 cm³ to about 10 cm³.

37. The device of claim 27, wherein the third chamber comprises a valve system which can be activated to allow hydrogen gas to exit the third chamber;

38. A system which comprises the self-regulating hydrogen generation device of claim 1 and a hydrogen consuming device.

39. The system of claim 38, wherein the hydrogen consuming device comprises an element which is capable of activating a valve system which is comprised in the third chamber of the hydrogen generation device to allow hydrogen gas in the third chamber to pass into the hydrogen consuming device.

40. The system of claim 38, wherein the hydrogen generation device is capable of being sealingly connected to the hydrogen consuming device in a way such that hydrogen gas in the third chamber of the hydrogen generation device is able to pass into the hydrogen consuming device.

41. The system of claim 38, wherein the hydrogen generation device and the hydrogen consuming device are connected by a system which comprises a quick-butt joint.

42. The system of claim 38, wherein the hydrogen consuming device is an integral part of the hydrogen generation device.

43. The system of claim 38, wherein the hydrogen consuming device comprises a fuel cell.

44. The system of claim 43, wherein the fuel cell is adapted for charging a portable electronic device.

45. The system of claim 44, wherein the fuel cell is adapted to provide from about 1 wt to about 50 wt.

46. A system of the self-regulating hydrogen generation device of claim 27 and a hydrogen-based fuel cell.

47. A hydrogen-based fuel cell which is adapted for being sealingly connected to the device of claim 1 and for receiving hydrogen gas therefrom.

48. A method of generating hydrogen gas in a self-regulating manner, wherein the method comprises contacting a catalytic material with a liquid material which is capable of forming hydrogen gas when contacted with the catalytic material and using the hydrogen gas thus formed for substantially preventing fresh liquid material from contacting the catalytic material when a predetermined threshold gas pressure is reached.

49. The method of claim 48, wherein the method comprises using a device which comprises
(a) at least one first chamber for holding a liquid and at least one first substance which is a source of hydrogen and is at least partly soluble in the liquid;
(b) adjacent to the at least one first chamber, a second chamber for holding at least one second substance which is capable of catalyzing a reaction which involves the at least one first substance and results in the formation of hydrogen gas;
(c) adjacent to the second chamber, a third chamber which is capable of holding gas;
(d) arranged between the first chamber and the second chamber, a first separation element which is liquid-permeable and capable of allowing liquid to pass from the first chamber into the second chamber; and
(e) arranged between the second chamber and the third chamber, a second separation element which is substantially liquid-impervious and gas-pervious, thereby allowing hydrogen gas present in the second chamber to pass into the third chamber.

50. The method of claim 48, wherein the method is used for supplying hydrogen to a hydrogen consuming device.

51. The method of claim 50, wherein the hydrogen consuming device comprises a hydrogen-based fuel cell.

52. A self-regulating hydrogen generation device wherein a catalytic material is contacted with a liquid material which is capable of forming hydrogen gas when contacted with the catalytic material and the hydrogen gas thus formed is used for substantially preventing fresh liquid material from contacting the catalytic material when a predetermined threshold gas pressure is reached.

53. A system which comprises the hydrogen generation device of claim 52 and a hydrogen consuming device.
